(19) United States
(12) Patent Application Publication
(10) Pub. No.: US 2023/0005510 A1
(43) Pub. Date: Jan. 5, 2023

(54) INFORMATION PROCESSING DEVICE AND METHOD, AND PROGRAM

(71) Applicant: SONY GROUP CORPORATION, TOKYO (JP)

(72) Inventors: YUKI YAMAMOTO, TOKYO (JP); TORU CHINEN, TOKYO (JP)

(21) Appl. No.: 17/782,970

(22) PCT Filed: Dec. 4, 2020
(86) PCT No.: PCT/JP2020/045172

§ 371 Date: Jun. 6, 2022

(30) Foreign Application Priority Data
Dec. 18, 2019 (JP) 2019-228139

(51) Int. Cl. G11B 27/34; G11B 27/30

(52) U.S. Cl. CPC G11B 27/34; G11B 27/3036

(57) ABSTRACT

The present technology relates to an information processing device and a method, and a program capable of improving creation efficiency of content.

An information processing device includes a determination unit that, in a case where time-series display information regarding an audio signal of each of a plurality of tracks is arranged and displayed, determines a display sequence of the display information of the plurality of tracks or a time position of a marker indicating switching of a scene in the audio signal of the plurality of tracks on the basis of the audio signal of each of the plurality of tracks or audio related information regarding each of the plurality of the audio signals. The present technology can be applied to a creation tool for content.

### TECHNICAL FIELD

The present technology relates to an information processing device and a method, and a program, and particularly relates to an information processing device and a method, and a program capable of improving creation efficiency of content.

### BACKGROUND ART

Conventionally, a digital audio workstation (DAW) or the like is known as a creation tool for music content.

In the DAW, it is possible to produce a music content by performing work such as waveform editing and effect addition in units of tracks.

Furthermore, for example, as a technique related to creation of music content, a technique for enabling designation of a position of an audio object on a user interface of 3D graphics, and the like have also been proposed (see, for example, Non-Patent Document 1).

### CITATION LIST

### Non-Patent Document

Non-Patent Document 1: Dolby Laboratories, Inc., “Authoring for Dolby Atmos® Cinema Sound Manual”, [online], [searched on Dec. 3, 2019], the Internet <https://www.dolby.com/us/en/technologies/dolby-atmos/authoring-for-dolby-atmos-cinema-sound-manual.pdf>

### SUMMARY OF THE INVENTION

### Problems to be Solved by the Invention

Meanwhile, in a case where editing work is performed in units of tracks in the DAW, waveform information of an audio signal of each track, a marker indicating a time position of switching of a scene in a music content, and the like can be displayed on an editing screen.

At this time, the user who is the creator of the music content may change the display sequence of the waveform information of each track or set the marker at an arbitrary time position, thereby facilitating creation work of the music content.

However, since the user has to manually perform an operation of changing the display sequence and setting the marker, the operation takes time, and it is difficult to improve creation efficiency of the music content.

The present technology has been made in view of such a situation, and an object thereof is to enable improvement of creation efficiency of content.

### Solutions to Problems

An information processing device of one aspect of the present technology includes a determination unit that, in a case where time-series display information regarding an audio signal of each of a plurality of tracks is arranged and displayed, determines a display sequence of the display information of the plurality of tracks or a time position of a marker indicating switching of a scene in the audio signal of the plurality of tracks on the basis of the audio signal of each of the plurality of tracks or audio related information regarding each of the plurality of the audio signals.

An information processing method or program of one aspect of the present technology includes a step of, in a case where time-series display information regarding an audio signal of each of a plurality of tracks is arranged and displayed, determining a display sequence of the display information of the plurality of tracks or a time position of a marker indicating switching of a scene in the audio signal of the plurality of tracks on the basis of the audio signal of each of the plurality of tracks or audio related information regarding each of the plurality of the audio signals.

In one aspect of the present technology, in a case where time-series display information regarding an audio signal of each of a plurality of tracks is arranged and displayed, there is determined a display sequence of the display information of the plurality of tracks or a time position of a marker indicating switching of a scene in the audio signal of the plurality of tracks on the basis of the audio signal of each of the plurality of tracks or audio related information regarding each of the plurality of the audio signals.

### BRIEF DESCRIPTION OF DRAWINGS

FIG. 1 is a diagram describing editing by a creation tool.

FIG. 2 is a diagram illustrating an editing screen example.

FIG. 3 is a diagram describing determination of a track display sequence.

FIG. 4 is a diagram describing determination of the track display sequence.

FIG. 5 is a diagram describing determination of the track display sequence.

FIG. 6 is a diagram illustrating a configuration example of an information processing device.

FIG. 7 is a flowchart describing an editing screen display process.

FIG. 8 is a diagram describing setting of markers.

FIG. 9 is a diagram describing determination of an automatic marker time position.

FIG. 10 is a diagram describing determination of the automatic marker time position.

FIG. 11 is a diagram describing determination of the automatic marker time position.

FIG. 12 is a view for describing setting of an automatic marker.

FIG. 13 is a view for describing setting of the automatic marker.

FIG. 14 is a diagram illustrating a configuration example of an information processing device.

FIG. 15 is a flowchart describing an editing screen display process.

FIG. 16 is a diagram illustrating a configuration example of a computer.

### MODE FOR CARRYING OUT THE INVENTION

### First Embodiment

<About Present Technology>

The present technology improves creation efficiency of music content by automatically determining a display sequence of display information regarding an audio signal of a track and a time position of a marker on the basis of at least one of the audio signal of each track or other information in a creation tool for music content.

First, as an embodiment of the present technology, an example will be described in which a display sequence of time-series display information regarding the audio signal of the track is determined (changed) on the basis of at least one of the audio signal of each track or other information.

In this case, for example, the creation efficiency can be further improved by determining the display sequence of the display information according to a time section designated by a user who is a creator of the music content.

Furthermore, information used for determining the display sequence of the display information can be set by the user, for example. Thus, it is possible to achieve determination of the display sequence that matches the user's intention and improve usability of the creation tool.

Note that, in the following, a case where a music content including audio signals of a plurality of tracks is produced will be described as an example, but the present technology can be applied to any content as long as the audio content includes a plurality of audio signals.

Hereinafter, embodiments to which the present technology is applied will be described with reference to the drawings.

In general, a user produces a music content including audio signals of a plurality of tracks using the creation tool.

Here, the audio signal of one track is, for example, an audio signal for reproducing a sound of an arbitrary audio object such as a musical instrument or a vocal, and the audio signal may be a signal of one channel, such as a signal of an R channel.

For example, on an editing screen of the creation tool for music content, waveform information and the like of audio signals of a plurality of respective tracks constituting the music content are arranged and displayed in a predetermined display sequence as time-series display information regarding the audio signals of the tracks.

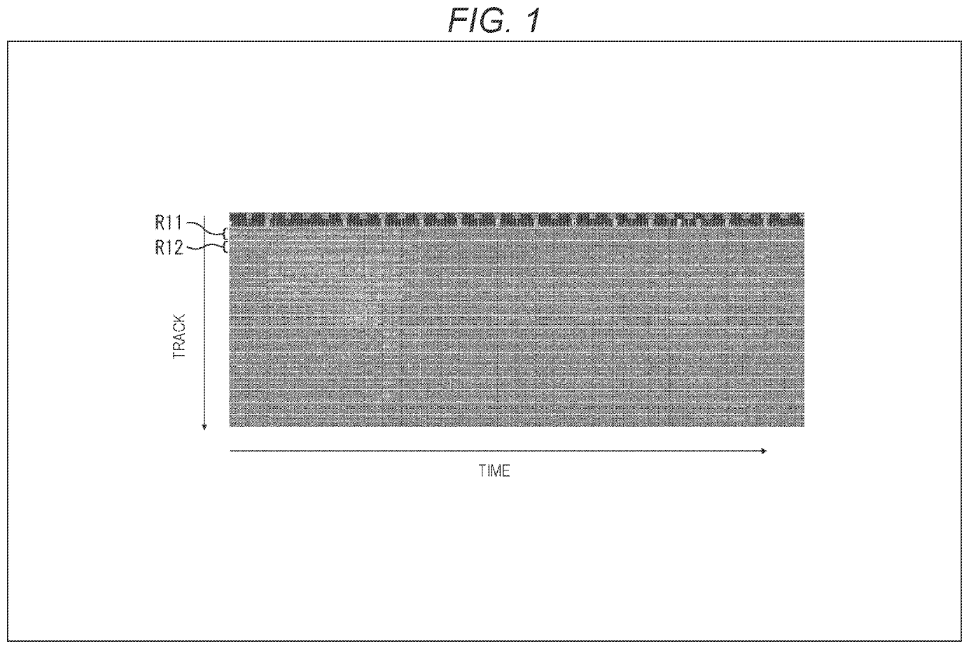

Specifically, for example, as illustrated in FIG. 1, waveform information of the audio signal of one track, that is, a time waveform is displayed as display information in a portion of an information display area R11 that is one rectangular area long in the horizontal direction on the editing screen.

Similarly, waveform information of the audio signal of another track different from the track corresponding to the information display area R11 is displayed as display information in a portion of an information display area R12 provided adjacent to a lower side of the information display area R11 in the diagram.

Here, the horizontal direction indicates time, and the right direction in the diagram is a future direction of time.

On the editing screen of the creation tool, a plurality of other information display areas is also provided on a lower side of the information display area R12 in the diagram in an arranged manner, and the waveform information of the audio signal of the track is displayed in these information display areas.

Hereinafter, an order (display sequence) in which the time-series display information regarding the audio signal of the track such as the waveform information of the audio signal of the track is arranged is referred to as a track display sequence.

In such the creation tool for music content, the user can produce the music content by performing work such as waveform editing and effect addition in units of tracks, that is, independently for each track while viewing the editing screen.

At this time, for example, if the user can change the track display sequence so that the display information of each of a plurality of respective tracks having similar features is arranged adjacent to each other on the editing screen, creation efficiency of the music content can be improved.

For example, in the example illustrated in FIG. 1, from an upper end portion to a lower end portion of the editing screen, the waveform information of each track is arranged and displayed in the order of earliness of start timings of sound units of the audio signals of the tracks.

Here, when attention is paid to a track in which the waveform information is displayed in the information display area R11 and a track in which the waveform information is displayed in the information display area R12 adjacent to the information display area R11, start timings of sound units in the audio signals of these two tracks are substantially the same.

For example, in a case where the work of collectively editing the tracks that appear in order from the head of the music content is performed, if the waveform information of the tracks is arranged and displayed in an order of start timings of sound units of the audio signals as in the example illustrated in FIG. 1, efficiency of editing work can be improved.

Similarly, for example, if the display information of respective tracks such as the waveform information is arranged and displayed in a sequence based on some features of the track, it is possible to improve efficiency of work of collectively editing the plurality of tracks having similar features.

For example, the user often changes the track display sequence on the basis of the start timing of the sound unit of the audio signal, the sound pressure of the audio signal, and other information regarding the audio signal of the track.

Here, the other information regarding the audio signal of the track is, for example, musical instrument information, priority information, reverberation information, sound information, position information, and the like of the audio signal (audio object) of the track.

As described above, if the track display sequence is changed, display information such as waveform information of a plurality of tracks having some similar features can be arranged close to each other on the editing screen.

This makes it easier for the user to recognize the arrangement positions of tracks having similar features as compared with a case where display information of a plurality of tracks having similar features is not arranged nearby.

Furthermore, the plurality of tracks having similar features is often edited together. Therefore, if the display information of the plurality of tracks having similar features is arranged close to each other, the user can quickly switch the track to be selected as a target of editing by operating an input device such as a mouse or a keyboard.

From these, by appropriately changing the track display sequence, the efficiency of editing work can be improved, and thus the creation efficiency of the music content can be improved.

However, in a general creation tool, a user has to manually change the track display sequence by operating an input device such as a mouse, and it has been difficult to improve the creation efficiency.

Moreover, for example, the track display sequence with which the creation efficiency improves may be different for each time section of the music content, but it takes time to manually change the track display sequence for each time section, lowering the creation efficiency. Conversely, in a case where the track display sequence is not changed, it takes time to perform the editing work, and the creation efficiency is lowered.

Accordingly, in the present technology, it is possible to improve the creation efficiency of the music content by automatically determining (changing) the track display sequence which has been manually performed so far.

In other words, in the present technology, it is possible to improve the creation efficiency of the music content by determining the track display sequence on the creation tool side without requiring an operation of changing the track display sequence by the user.

Moreover, in the present technology, the creation efficiency can be further improved by determining the track display sequence for each time section designated by the user.

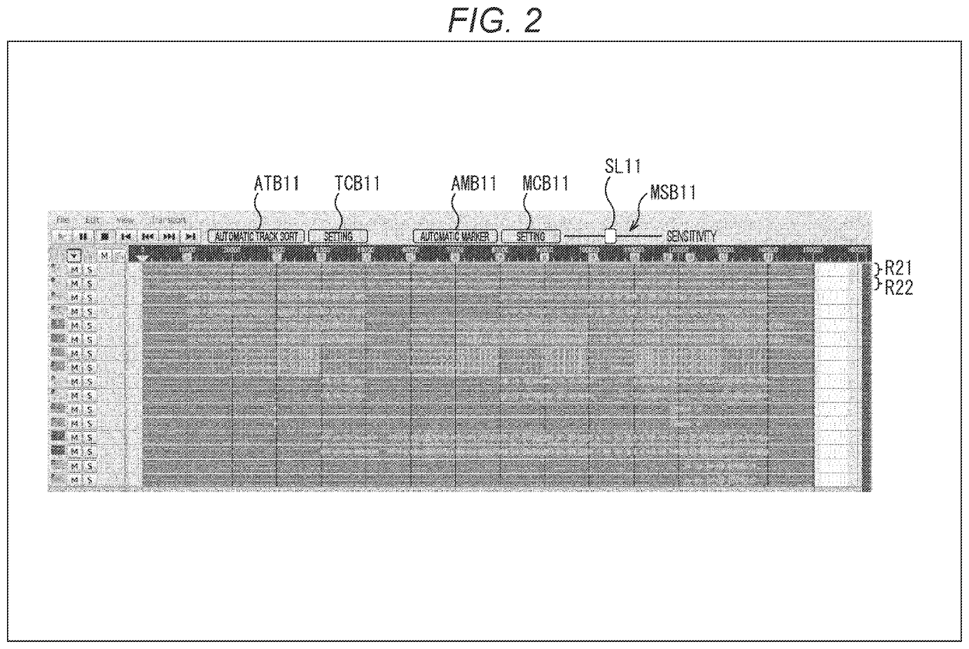

In the creation tool to which the present technology is applied, for example, an editing screen illustrated in FIG. 2 is displayed.

In the example illustrated in FIG. 2, similarly to the example illustrated in FIG. 1, the right direction in the diagram is the future direction of time, and the waveform information of the audio signal of one track is displayed as time-series display information in a portion of one rectangular information display area R21 that is long in the horizontal direction on the editing screen.

Similarly, the waveform information of the audio signal of another track different from the track corresponding to the information display area R21 is displayed in a portion of the information display area R22 provided adjacent to a lower side of the information display area R21 in the diagram.

For example, in the example illustrated in FIG. 2, the waveform information of respective tracks is arranged and displayed in the order of earliness of start timings of the sound units of the audio signals of the tracks from a portion (hereinafter, also referred to as an upper end portion) of the information display area on the uppermost side in the diagram on the editing screen to a portion (hereinafter, also referred to as a lower end portion) of the information display area on the lowermost side in the diagram.

While viewing such an editing screen, the user produces a music content by performing work such as waveform editing and effect addition independently in units of tracks, that is, for each track.

Note that an example in which the waveform information of the audio signal is displayed as the display information in the information display area will be described here, but the display information displayed in the information display area may be any information as long as it relates to the audio signal of the track.

For example, the position information of the audio object corresponding to the audio signal at each time, priority information of the audio signal (audio object) at each time, gain information of the audio signal at each time, and the like may be used as the display information, or a plurality of pieces of information may be combined and displayed as the display information.

Furthermore, in the example illustrated in FIG. 2, an automatic track sort button ATB11, an automatic track sort setting button TCB11, an automatic marker button AMB11, an automatic marker setting button MCB11, and an automatic marker sensitivity bar MSB11 are provided in a tool bar portion at the upper part of the editing screen.

For example, the automatic track sort button ATB11 is a button for automatically determining (changing) the track display sequence.

When the automatic track sort button ATB11 is operated by the user, the track display sequence is determined (changed) on the creation tool side, and the display of the editing screen is updated according to a determination result. That is, the display information of each track is sorted.

The automatic track sort setting button TCB11 is a button for setting related to determination of the track display sequence.

By operating the automatic track sort setting button TCB11, the user can designate what kind of information on the basis of which the track display sequence is determined on the creation tool side.

The automatic marker button AMB11 is a button for automatically setting a marker indicating a specific time position of the music content to be described later. The user can cause the marker to be set and displayed on the creation tool side by operating the automatic marker button AMB11.

The automatic marker setting button MCB11 is a button for setting related to automatic setting of the marker, and the user can designate what kind of information on the basis of which the automatic setting of the marker is performed by operating the automatic marker setting button MCB11.

The automatic marker sensitivity bar MSB11 is for adjusting sensitivity of the automatic setting of the marker. That is, the user can adjust the number of markers automatically set by moving a slider SL11 provided on the automatic marker sensitivity bar MSB11 to the left and right.

Here, determination of the track display sequence performed when the automatic track sort button ATB11 is operated will be specifically described.

As described above, the user who is the creator of the music content often changes the track display sequence on the basis of the start timing of the sound unit of the audio signal, the sound pressure of the audio signal, and other information regarding the audio signal of the track (hereinafter, referred to as audio related information).

The audio related information is, for example, musical instrument information, priority information, reverberation information, sound information, position information, and the like of the audio signal (audio object) of the track.

In the creation tool, the start timing of the sound unit of the audio signal, the sound pressure of the audio signal, and the audio related information are calculated and acquired, and are used for determining the track display sequence.

(A1) Determination of Track Display Sequence Based on Audio Signal

First, determination of the track display sequence based on the audio signal will be described.

A sound pressure power(itrack, ifrm) in a certain time section (hereinafter, also referred to as a time frame) of the audio signal of the track constituting the music content can be obtained by the following Expression (1).

$$\begin{matrix}[ Expression 1 ] & \\ power ( itrack , ifrm ) = 10 \times {log}_{10} ( \frac{{\sum }_{ismp = ifrm \times nsmp}^{( ifrm + 1 ) \times nsmp - 1} {sig ( itrack , ismp )}^{2}}{nsmp} ) & ( 1 )\end{matrix}$$

Note that in Expression (1), itrack represents the index of the track, and ifrm represents the index of the time frame. Furthermore, nsmp represents the number of samples of the audio signal per hour frame, and ismp represents a sample index of the audio signal.

Moreover, sig(itrack, ismp) indicates a sample value of the sample index ismp of the audio signal of the itrack-th track.

Here, as a method of determining the track display sequence on the basis of the audio signal, two methods of determining the track display sequence on the basis of the sound pressure power(itrack, ifrm) obtained from the audio signal by calculation of Expression (1) will be described.

(A1-1) Setting to Sequence of Start Timings of Sound Units of Audio Signal

As a first method, an example will be described in which the order of the start timings of the sound units of the audio signals of the tracks is the track display sequence.

For example, the start timing of the sound unit of the audio signal of the track can be obtained by performing a threshold process on the sound pressure power(itrack, ifrm) obtained by the above-described Expression (1).

Specifically, for example, a time frame in which the sound pressure power(itrack, ifrm) changes from a value less than a predetermined threshold th determined in advance to a value equal to or more than the threshold th can be set as the start timing of the sound unit.

Therefore, by specifying the index ifrm of such a time frame, the time position of the start timing of the sound unit (hereinafter also referred to as a sound unit start position) of the audio signal of the track can be obtained.

If such a sound unit start position is calculated for all tracks and the track display sequence is determined so that the indexes ifrm indicating the sound unit start positions are in ascending order, the waveform information and the like of each track can be displayed in the order of earliness of start timing of the sound unit of the audio signal.

In this case, for example, as illustrated in FIG. 2, the track display sequence becomes faster as the sound unit start position is closer to the head position (start position) of the audio signal, and the waveform information and the like are displayed on the upper end portion side of the editing screen.

Note that the threshold th for determining the start timing of the sound unit may be set in advance or may be settable by the user.

(A1-2) Setting to Sequence of Sound Pressure Average Values of Audio Signals

Next, as a second method, an example in which the order of sound pressure average values of the audio signals of the tracks is set to the track display sequence will be described.

The sound pressure average value power_mean(itrack), which is the average value of the sound pressure power(itrack, ifrm) in each time frame of the audio signal of one track in the predetermined time section, can be obtained by the following Expression (2).

$$\begin{matrix}[ Expression 2 ] & \\ power\_mean ( itrack ) = \frac{{\sum }_{ifrm = start\_frm}^{stop\_frm} power ( itrack , ifrm )}{( stop\_frm - start\_frm + 1 )} & ( 2 )\end{matrix}$$

Note that, in Expression (2), start_frm indicates the index ifrm of the time frame at a start position of the time section for which the track display sequence is to be determined, and stop_frm indicates the index ifrm of the time frame at an end position of the time section for which the track display sequence is to be determined.

If such a sound pressure average value power_mean(itrack) is calculated for all tracks and the track display sequence is determined so that the sound pressure average values power_mean(itrack) are in descending order, the display information such as the waveform information of respective tracks can be displayed in descending order of the sound pressure average value power_mean(itrack) of the audio signal.

That is, in this case, the track display sequence becomes faster as the sound pressure average value power_mean(itrack) is larger, and the display information such as the waveform information is displayed on the upper end portion side of the editing screen.

In general, a track having a large sound pressure average value power_mean(itrack) is often an important track constituting the music content, and the user often performs editing in order from such an important track. Therefore, if the track display sequence is determined on the basis of the sound pressure average value power_mean(itrack), the creation efficiency of the music content can be improved.

(A2) Determination of Track Display Sequence Based on Audio Related Information

(A2-1) Setting to Sequence According to Musical Instrument Information

Next, an example of determining the track display sequence on the basis of the audio related information will be described.

First, as a first method, an example of determining the track display sequence on the basis of the musical instrument information as the audio related information will be described.

The musical instrument information is information indicating the type of audio signal of a track, such as a “vocal”, “drums”, a “bass”, a “guitar”, and a “piano”. That is, the musical instrument information is information indicating what sound source type of the sound source the audio signal of the track is from.

More specifically, the musical instrument information is information indicating the type of the audio object such as the musical instrument, the sound part, and the gender of voice of male, female, or the like, that is, attributes of the audio object itself serving as the sound source.

Accordingly, it is conceivable to determine the track display sequence on the basis of the musical instrument information added to each audio signal of the track.

For example, by setting the track display sequence in which tracks to which the same musical instrument information is added are arranged in succession, the waveform information and the like of a plurality of tracks to which the same musical instrument information is added can be collectively arranged on the editing screen.

Thus, the waveform information and the like of each track constituting one track group (group) such as a track group of “vocal”, a track group of “drums”, and a track group of “guitar” are displayed (arranged) so as to be successively arranged on the editing screen. Therefore, the user can edit the track collectively for each musical instrument, and the creation efficiency of the music content can be improved.

Note that the musical instrument information of each track may be manually set (designated) by the user, or may be automatically set by various types of processing for the audio signal such as recognition processing using a recognition device obtained by learning. For example, the user may designate the musical instrument information of each track by operating a pull-down box or the like on the editing screen.

Moreover, the musical instrument information may be automatically set from the character string of a track name of the track set by the user, the file name of the audio signal of the track, and the like.

(A2-2) Setting to Sequence According to Priority Information

As a second method, an example of determining the track display sequence on the basis of the priority information as the audio related information will be described.

The priority information is information indicating the importance (priority) of the audio signal of the track.

For example, the priority information may be set to any of “high” with the highest importance, “medium” with the medium importance, and “low” with the lowest importance, or the priority information may be represented by a numerical value, and the track (audio signal) may be so that the importance is higher as the value is larger.

For example, in a case where the priority information is represented by a numerical value, and the importance is higher as the value is larger, if the track display sequence is determined such that the values of the priority information are in descending order, the waveform information and the like are displayed closer to the upper end portion side of the editing screen as the track is more important. Therefore, the user can proceed with the editing work from a more important track, and the creation efficiency of the music content can be improved.

Note that the priority information of each track may be manually set (designated) by the user, or may be automatically set from the sound pressure, metadata, or the like of the audio signal of the track.

Specifically, for example, on the basis of the position information of the audio object corresponding to the track included in the metadata of the audio signal of the track, the track of the audio object at a position closer to the listener of the music content can be set to have higher importance (priority). Similarly, for example, the track of the audio object closer to the front direction of the listener can be set to have higher importance.

A method for determining the priority information on the basis of the metadata of the audio signal or the like is described in detail in, for example, WO 2018/198789 A.

(A2-3) Setting to Sequence According to Reverberation Information and Sound Information

As a third method, an example of determining the track display sequence on the basis of reverberation information or sound information as audio related information will be described.

The reverberation information is information indicating a reverberation effect added to the audio signal of the track, for example, dry, short reverb, long reverb, or the like, that is, a reverberation characteristic of the audio signal. Note that, for example, the dry indicates that no reverberation effect is applied to the audio signal.

Furthermore, the sound information is, for example, information indicating a sound effect other than reverberation to be added to the audio signal of the track, such as natural “natural” or distortion “dist”. Note that the natural indicates that no effect is applied particularly to the audio signal. Hereinafter, in a case where the reverberation effect and other effects are not particularly distinguished, they are simply referred to as sound effects.

It is conceivable to determine the track display sequence on the basis of such reverberation information and sound information of each track.

For example, by setting the track display sequence in which tracks to which the same reverberation information or the same sound information is added are arranged in succession, the waveform information and the like of a plurality of tracks to which the same sound effect is applied can be collectively arranged on the editing screen.

Thus, for example, it is possible to improve efficiency of work of collectively editing tracks to which the same reverberation information and sound information are added, that is, tracks to which the same sound effect is applied, and consequently, it is possible to improve the creation efficiency of the music content.

Note that the reverberation information and the sound information may be manually set (designated) by the user, or may be automatically set by various analysis processes or the like on the audio signal. Moreover, the reverberation information and the sound information may be automatically set from a character string or the like of a track name of the track set by the user.

(A2-4) Sequence According to Position Information

Moreover, as a fourth method, an example of determining the track display sequence on the basis of the position information as the audio related information will be described.

The position information is information indicating a localization position of a sound of the sound source (audio object) corresponding to a track, that is, a sound based on the audio signal of the track.

For example, the position information can be set to any one of “Center” in which the localization position is in front of the listener, “R” in which the localization position is a position on the right side as viewed from the listener, or “L” in which the localization position is a position on the left side as viewed from the listener.

Furthermore, for example, in the content of two channels, the localization position may be expressed by a pan value obtained by gain values assigned to the respective speakers of L channel and R channel.

Moreover, for example, in a content of 3D audio, the localization position may be represented by a horizontal angle, a vertical angle, and a distance.

Here, the horizontal angle constituting the position information is an angle indicating the position of a sound source in the horizontal direction viewed from a predetermined reference position such as the position of the listener, and the vertical angle is an angle indicating the position of the sound source in the vertical direction viewed from the reference position. Furthermore, the distance constituting the position information is a distance from the reference position to the sound source.

It is conceivable to determine the track display sequence on the basis of such position information for each track.

For example, if the track display sequence is determined so that the horizontal angles constituting the position information are in ascending order, the waveform information and the like are displayed on the upper end portion side of the editing screen as the track of the sound source localizes in a direction closer to the front of the listener, which is more easily perceived by the listener.

Therefore, the user can proceed with the editing work from the track of the sound source that is more easily perceived by the listener, and the creation efficiency of the music content can be improved.

Furthermore, for example, if the track display sequence is determined so that the temporal change amount of the position information is in descending order, the waveform information and the like are displayed on the upper end portion side of the editing screen as the track of the sound source moves faster. Therefore, the user can proceed with the editing work from the track of the sound source moving faster, and the creation efficiency of the music content can be improved.

Note that the position information of each track may be manually set (designated) by the user in the creation tool for music content, or may be automatically set on the basis of the musical instrument information, the reverberation information, the sound information, the priority information, the channel information, the audio signal, and the like of the track.

Specifically, for example, a decision tree or the like in which the musical instrument information, the reverberation information, the sound information, the priority information, and the channel information of the track are input and position information of the track is output may be prepared in advance by learning. In this case, the musical instrument information, the reverberation information, the sound information, the priority information, and the channel information obtained for the track are input to the decision tree to perform calculation, and an output value obtained as a result of the calculation is used as the position information of the track.

Note that the channel information is information indicating channels such as L and R of stereo and C, L, R, Ls, and Rs of 5.1 ch, for example.

Furthermore, for example, the position information, the priority information, and the like at each time are displayed as time-series display information on the editing screen, and the user can manually designate the position information and the priority information by performing an operation on the display information.

As described above, in the present technology, the track display sequence is determined on the basis of the audio signal and the audio related information of each track.

At this time, the audio signal and the audio related information used for determining the track display sequence may be for the entire time section of the music content, or may be for the time section designated by the user.

For example, if the track display sequence is determined on the basis of the audio signal and the audio related information of each track for each time section designated by the user, even in a case where the track display sequence for improving the creation efficiency is different for each time section of the music content, the track display sequence can be appropriately determined for each time section, and the creation efficiency can be improved.

Furthermore, for example, in a case where the track display sequence is determined for each of a plurality of time sections, the user may designate the entire time section, that is, the start position and the end position of the time section, or the user may designate only the start position or the end position of the time section.

Moreover, the track display sequence may be determined by using any plurality of pieces of information among the audio signal of the track, the musical instrument information as the audio related information, the priority information, the reverberation information, the sound information, the position information, and the like described above in combination. In particular, in such a case, the user may be allowed to set (designate) which information is used for determining the track display sequence.

In a case where the user designates one or a plurality of pieces of information to be used for determining the track display sequence, for example, it is only required to operate the automatic track sort setting button TCB11 in a state where the editing screen illustrated in FIG. 2 is displayed.

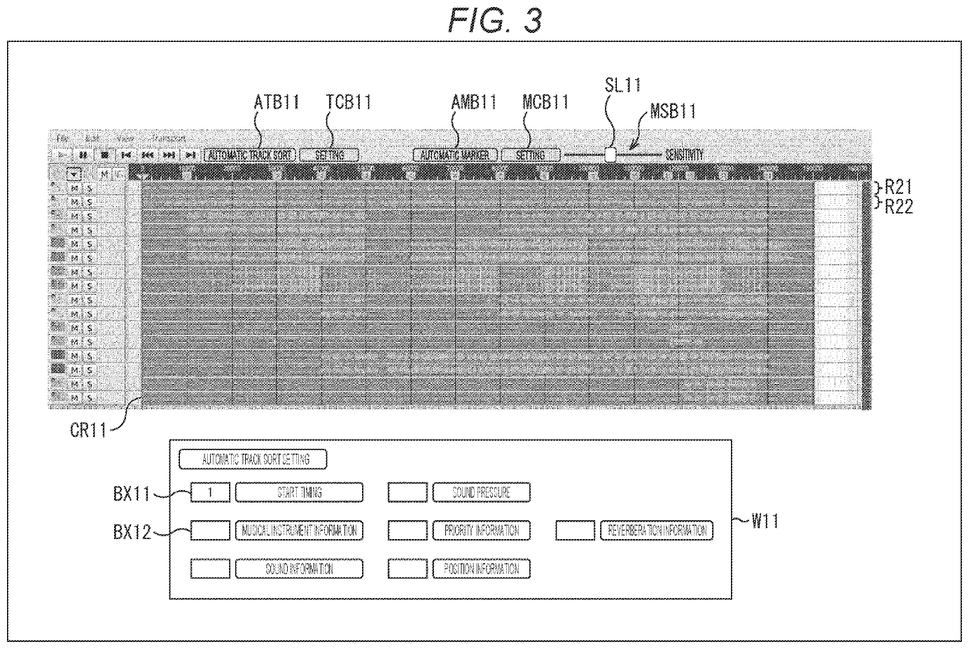

When the automatic track sort setting button TCB11 is operated by the user, for example, as illustrated in FIG. 3, an automatic track sort setting window W11 is displayed by superimposing on the editing screen. Note that, in FIG. 3, portions corresponding to those in the case of FIG. 2 are denoted by the same reference numerals, and the description thereof will be omitted as appropriate.

In the example of FIG. 3, a cursor CR11 indicating a reproduction position of the music content, that is, the time position to be edited is displayed on the editing screen, and here, a cursor CR11 indicates the head position of the music content. In other words, it is a state that the section from the start to the end of the music content is designated as the time section for which the track display sequence is to be determined.

In the automatic track sort setting window W11, letters indicating information available for determining the track display sequence and a text box for selecting (designating) to use the information are arranged and displayed.

For example, a text box BX11 arranged next to the letters “start timing” is for designating the start timing of the sound unit of the audio signal of the track as information used for determining the track display sequence.

Similarly, for example, the text box BX12 arranged next to the letters “musical instrument information” is for designating the musical instrument information of the audio signal of the track as the information used for determining the track display sequence.

In addition, in the automatic track sort setting window W11, a text box for designating the sound pressure (sound pressure average value), the priority information, the reverberation information, the sound information, and the position information of the audio signal as the information used for determining the track display sequence is also displayed.

In this example, the user can designate only one piece of information as the information used for determining the track display sequence, or can designate a plurality of pieces of information as the information used for determining the track display sequence.

In particular, in a case where a plurality of pieces of information is designated, the pieces of information can be prioritized. That is, the user can also designate the priority order of each of the pieces of information.

Specifically, the user inputs a numerical value indicating the priority order (priority) in the text box, such as inputting a numerical value “1” in the text box corresponding to the information with the highest priority order and inputting a numerical value “2” in the text box corresponding to the information with the next highest priority order.

In the example of FIG. 3, since the numerical value is input only to the text box BX11 and the numerical value is “1”, in the creation tool, the track display sequence is determined on the basis of only the start timing of the sound unit of the audio signal of the track.

In particular, in this example, since the cursor CR11 indicates the head position of the music content, the time section after the head position (start position) of the music content is set as the target time section in the creation tool. Then, in the target time section, the track display sequence is set to the order of earliness of start timing of the sound unit of the audio signal of the track.

In this manner, when the user operates the automatic track sort button ATB11 after displaying the automatic track sort setting window W11 and designating the information used for determining the track display sequence, the track display sequence is determined on the basis of the information designated by the user.

Then, the time-series display information of respective tracks is arranged and displayed on the editing screen according to a determination result of the track display sequence.

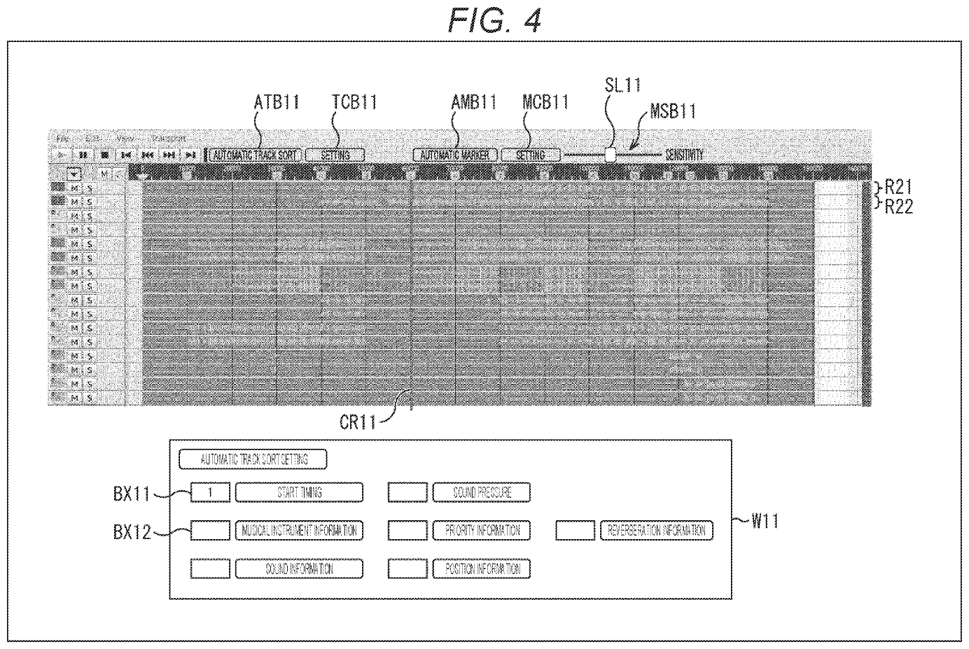

Similarly, for example, as illustrated in FIG. 4, when the user operates the automatic track sort button ATB11 in a state where the cursor CR11 indicates a predetermined position after the head position of the music content, a section after the predetermined position is set as the target time section, and the track display sequence is determined. Note that, in FIG. 4, portions corresponding to those in the case of FIG. 3 are denoted by the same reference numerals, and the description thereof will be omitted as appropriate.

Also in this example, similarly to the case in FIG. 3, in the automatic track sort setting window W11, a numerical value is input only to the text box BX11, and the numerical value is “1”.

Therefore, in the time section after the predetermined position indicated by the cursor CR11, the order of earliness of start timing of the sound unit of the audio signal of the track is determined as the track display sequence, and the display of the display information of the track is updated on the basis of a determination result.

As can be seen by comparing FIGS. 3 and 4, even if the information used for determining the track display sequence is the same, the track display sequence changes when the target time sections are different.

Therefore, when the user wants to change the condition for determining the track display sequence in the middle of editing the music content, that is, the information used for determining the track display sequence or the priority order of each piece of information, it is only required to operate the automatic track sort setting button TCB11 or the automatic track sort button ATB11 in a state that the cursor CR11 indicates a desired time position.

Note that information used for determining the track display sequence, or the like may be designated in advance for each of a plurality of time sections of the music content. In such a case, for example, at the timing when the cursor CR11 reaches the head position of a predetermined time section, the display of the editing screen, that is, the display of the display information portion of each track can be updated on the basis of the track display sequence in this time section.

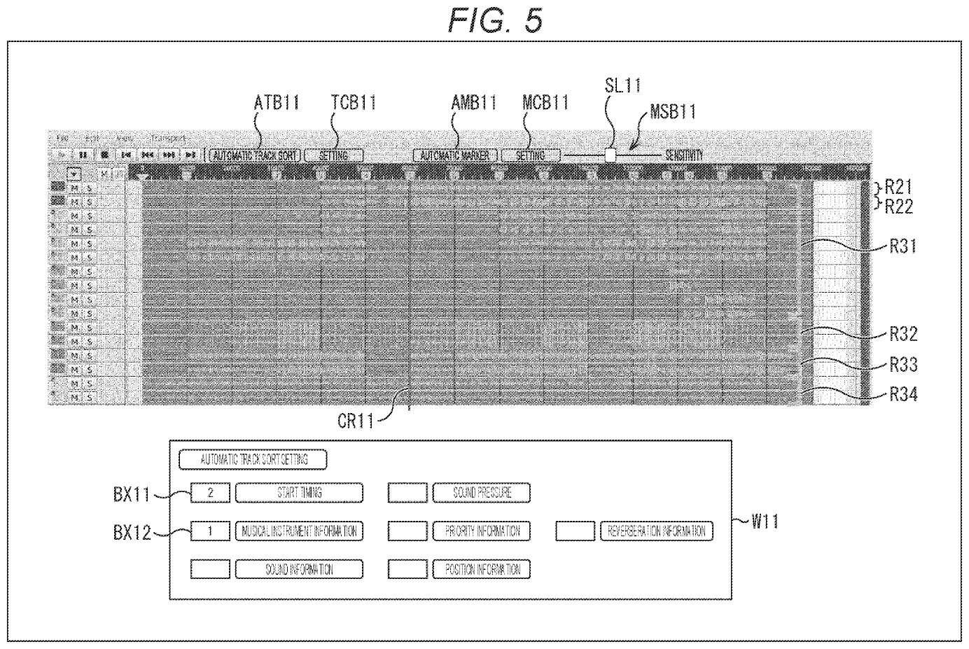

Furthermore, in a case where two or more, a plurality of pieces of information is designated as the information used for determining the track display sequence, for example, the track display sequence is determined as illustrated in FIG. 5. Note that, in FIG. 5, portions corresponding to those in the case of FIG. 3 are denoted by the same reference numerals, and the description thereof will be omitted as appropriate.

In the example of FIG. 5, in the automatic track sort setting window W11, a numerical value “1” is input to the text box BX12, and a numerical value “2” is input to the text box BX11.

Therefore, at the time of determining the track display sequence, first, the track display sequence of each track is determined on the basis of the musical instrument information with a higher priority order, and thereafter, between tracks of the same musical instrument information, the track display sequence is determined on the basis of the start timing of the sound unit with the next highest priority order.

In other words, each track is grouped by musical instrument information with a higher priority order, the display sequence of those groups is determined, and the display sequence in each group is determined on the basis of the start timing of the sound unit, thereby determining the track display sequence. That is, the track display sequence is hierarchically determined on the basis of a plurality of pieces of information such as the musical instrument information and the start timing of the sound unit.

More specifically, for example, it is assumed that the music content includes a total of 16 tracks. Furthermore, it is assumed that the number of tracks of which the musical instrument information is “vocal” is 10, the number of tracks of which the musical instrument information is “drums” is 2, the number of tracks of which the musical instrument information is “bass” is 2, and the number of tracks of which the musical instrument information is “piano” is 2.

In such a case, first, the tracks are grouped on the basis of the musical instrument information that is information having the highest priority order, and the display sequence of the groups is determined.

Here, grouping is performed such that one or a plurality of tracks having the same musical instrument information, such as a group including 10 tracks having musical instrument information of “vocal”, belongs to the same group, and the sequence determined in advance for the musical instrument information is determined as the display sequence of each group.

Subsequently, for each group, the display sequence of each track belonging to the group is determined on the basis of the start timing of the sound unit that is information having the next highest priority order. Here, the order of earliness of start timing of the sound unit is set as the display sequence of respective tracks in the group.

The final track display sequence of respective tracks is determined on the basis of the display sequence of the groups determined hierarchically in this manner and the display sequence of the tracks in the group, and the display of the editing screen is updated according to a determination result.

That is, in this example, in the area R31 on the upper end portion side of the editing screen, the waveform information of 10 respective tracks of which the musical instrument information is “vocal” is arranged and displayed in the track display sequence.

In particular, here, the waveform information of the respective tracks of which the musical instrument information is “vocal” is arranged and displayed in the order of earliness of start timing of the sound unit after the time position indicated by the cursor CR11.

Similarly, in the area R32 of the editing screen, the waveform information of two respective tracks of which the musical instrument information is “drums” is arranged and displayed in the track display sequence, and in the area R33, the waveform information of two respective tracks of which the musical instrument information is “bass” is arranged and displayed in the track display sequence.

Moreover, in the area R34 of the editing screen, the waveform information of two respective tracks of which the musical instrument information is “piano” is arranged and displayed in the track display sequence.

As described above, by designating a plurality of pieces of information used for determining the track display sequence, the display information of respective tracks can be further displayed in the display sequence that matches the user's intention. In particular, in the example of FIG. 5, it is possible to improve work efficiency of the editing work in which the tracks are edited collectively for each musical instrument and in the order of earliness of start timing of the sound unit.

<Configuration Example of Information Processing Device>

Next, a specific embodiment of an information processing device to which the present technology described above is applied will be described.

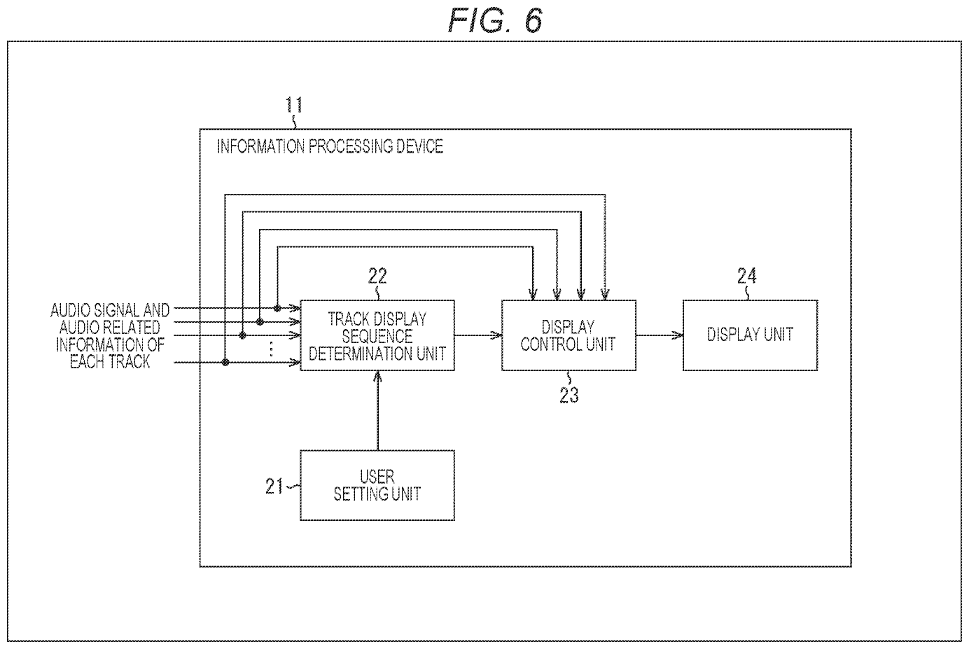

The information processing device to which the present technology is applied is configured as illustrated in FIG. 6, for example.

An information processing device 11 illustrated in FIG. 6 includes, for example, a personal computer and the like, and implements the creation tool for music content by executing a program.

The information processing device 11 includes a user setting unit 21, a track display sequence determination unit 22, a display control unit 23, and a display unit 24.

The user setting unit 21 supplies, to the track display sequence determination unit 22, designation information for designating information used for determining (changing) the track display sequence, a parameter used for determining the track display sequence, and time section information indicating the time section for which the track display sequence is to be determined in accordance with control such as a designation operation by the user.

Here, the designation information is information indicating what kind of information is used for determining the track display sequence, such as the start timing of the sound unit of the audio signal of the track, the sound pressure average value of the audio signal, and the musical instrument information as the audio related information.

Note that when the user designates a plurality of pieces of information as the information used for determining the track display sequence, information indicating the priority order of the designated information is also included in the designation information.

Furthermore, the parameter used at the time of determining the track display sequence is, for example, the threshold th for obtaining the start timing of the above-described sound unit, or the like.

The audio signal of each track of the music content and the audio related information of each track are supplied from the creation tool for music content to the track display sequence determination unit 22.

The track display sequence determination unit 22 determines the track display sequence for each time section indicated by the time section information on the basis of the supplied audio signal and audio related information of each track and the designation information, parameter, and time section information supplied from the user setting unit 21, and supplies a determination result to the display control unit 23.

The display control unit 23 generates display data of the editing screen on the basis of the audio signal and the audio related information of each track of the music content supplied from the creation tool for music content and the determination result of the track display sequence supplied from the track display sequence determination unit 22.

For example, the display control unit 23 generates image data for displaying the editing screen as the display data such that time-series display information such as the waveform information of each track is arranged and displayed in the order indicated by the track display sequence on the editing screen. The display control unit 23 supplies the generated display data to the display unit 24 to display the editing screen.

The display unit 24 includes, for example, a display or the like, and displays the editing screen on the basis of the display data supplied from the display control unit 23. Note that the display unit 24 may be provided outside the information processing device 11.

<Description of Editing Screen Display Process>

Next, operation of the information processing device 11 will be described.

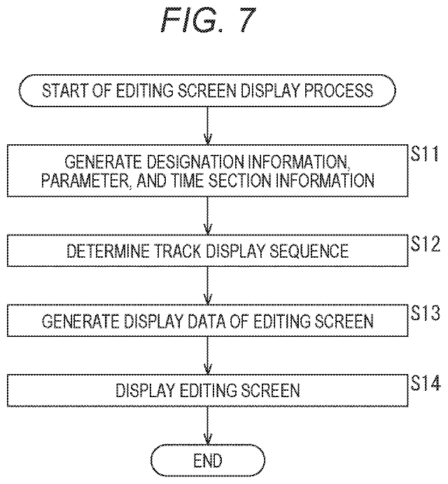

That is, the editing screen display processing by the information processing device 11 will be described below with reference to the flowchart of FIG. 7.

In step S11, the user setting unit 21 generates the designation information, the parameter, and the time section information, and supplies the designation information, the parameter, and the time section information to the track display sequence determination unit 22.

The designation information, the parameter, and the time section information may be generated according to an operation (designation) of the user, or predetermined designation information, parameter, and time section information may be generated.

For example, as illustrated in FIG. 5, in a case where the user displays the automatic track sort setting window W11 on the display unit 24 and inputs the priority order in a desired text box, the designation information corresponding to the input is generated. Furthermore, for example, the time section information is generated according to the time position of the cursor CR11 illustrated in FIG. 5.

In step S12, the track display sequence determination unit 22 determines the track display sequence for each time section indicated by the time section information on the basis of the supplied audio signal and audio related information of each track and the designation information, parameter, and time section information supplied from the user setting unit 21, and supplies a determination result to the display control unit 23.

For example, in a case where the track display sequence is determined on the basis of the audio signal according to the designation information, the track display sequence determination unit 22 calculates the above-described Expression (1) on the basis of the supplied audio signal, and obtains the sound pressure of the audio signal of each track.

Then, the track display sequence determination unit 22 performs the threshold process on the sound pressure of the audio signal of each track by using the threshold th as the parameter, obtains time positions of the start timings of the sound units of the audio signal, and determines the track display sequence on the basis of the time positions. That is, the track display sequence is determined on the basis of results of the threshold process.

Furthermore, for example, the track display sequence determination unit 22 calculates the above-described Expression (2) on the basis of the sound pressure of the audio signal for each track to obtain the sound pressure average value in the time section indicated by the time section information, and determines the track display sequence on the basis of the sound pressure average value.

Moreover, for example, in a case where the track display sequence is determined on the basis of the audio related information, the track display sequence determination unit 22 determines the track display sequence for the time section indicated by the time section information on the basis of the musical instrument information, the priority information, the reverberation information, the sound information, and the position information of each track indicated by the designation information.

In step S13, the display control unit 23 generates the display data of the editing screen on the basis of the supplied audio signal and audio related information of each track and the determination result of the track display sequence supplied from the track display sequence determination unit 22. Thus, for example, the display data for displaying the editing screen illustrated in FIG. 2 is generated.

Then, in step S14, the display control unit 23 supplies the generated display data to the display unit 24 to display the editing screen, and the editing screen display process ends.

As described above, the information processing device 11 determines the track display sequence on the basis of the audio signal and the audio related information of each track, and generates the display data of the editing screen.

In this manner, the display information can be arranged and displayed in an appropriate sequence without requiring an operation of changing the display sequence of the display information by the user, and the creation efficiency of the music content can be improved.

### Second Embodiment

<Marker Setting>

Incidentally, the example of determining the track display sequence on the basis of the audio signal and the audio related information of each track has been described above.

However, the present technology can also be applied to setting of a marker indicating switching of a scene in a music content.

That is, according to the present technology, in the creation tool for music content, the marker is automatically set on the basis of at least one of the audio signal or the audio related information of each track, and thereby the creation efficiency of the music content can be improved.

Furthermore, in the present technology, for example, information used for setting the marker can be set by the user. Thus, the setting of the marker that matches the user's intention can be achieved, and the creation efficiency of the music content can be further improved.

Moreover, in the present technology, the user can adjust the number of markers to be set. In this manner, it is possible to achieve the setting of the marker that matches the user's intention.

As described above, in general, the waveform information of the audio signals of the plurality of respective tracks constituting the music content is arranged and displayed in the predetermined display sequence on the editing screen of the creation tool for music content.

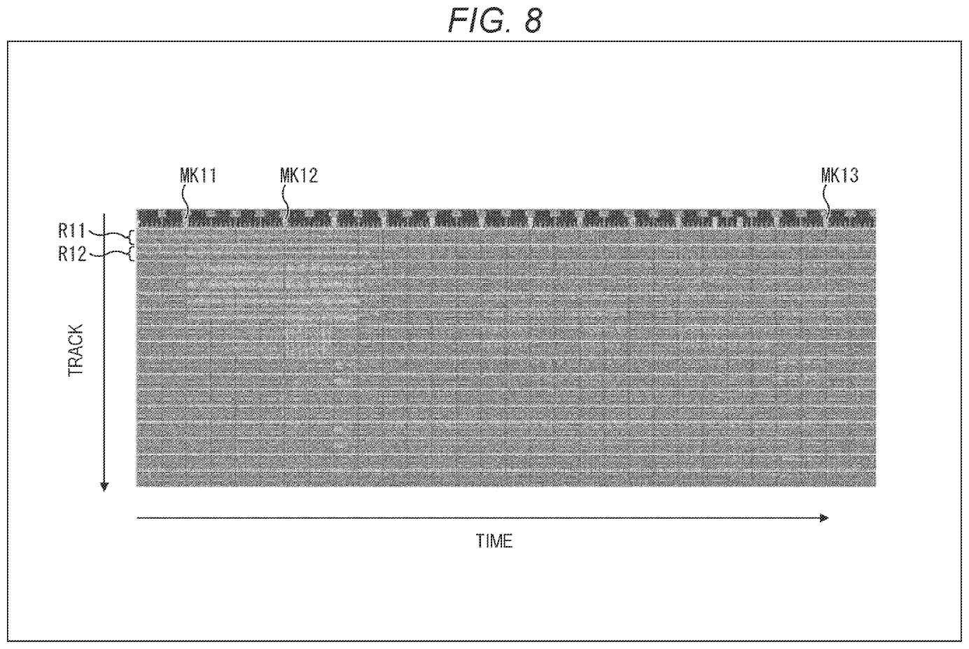

Specifically, for example, as illustrated in FIG. 8, the waveform information of the audio signal of one track is displayed as display information in a portion of the information display area R11 and the information display area R12 on the editing screen. Note that, in FIG. 8, portions corresponding to those in the case of FIG. 1 are denoted by the same reference numerals, and the description thereof will be omitted as appropriate.

Furthermore, on the editing screen of the creation tool, a marker indicating the time position of switching of a scene in the audio signal of each track, in other words, a marker indicating the time position of switching of a scene in the time-series display information of respective tracks is appropriately displayed.

In this example, for example, a marker MK11, a marker MK12, a marker MK13, and the like are displayed as markers indicating the time position of switching of a scene.

The scene referred to herein is a section such as intro, verse, bridge, chorus, interlude, and outro in the music content, and a marker is displayed at a switching position of these sections.

The intro is a prelude part (introduction) in a song, the verse is a first melody part following the prelude part, and the bridge is a second melody part following the verse. Furthermore, the chorus is the most exciting melody part in the song, the interlude is a performance part of only a musical instrument besides the prelude and the postlude of the song, and the “outro” is the postlude part of the song.

When the marker indicating the switching of a scene is displayed on the editing screen in this manner, the user who is the creator of the music content can quickly move the reproduction position of the music content to the time position of the marker by, for example, a keyboard shortcut key or the like.

Thus, since reproduction from the time position of the marker can be performed in a short time, the user can perform sound quality comparison, sound quality adjustment, and the like between scenes in a short time.

However, in a general creation tool, since it is necessary for the user to manually set the marker, and the setting work takes time, it is difficult to improve the creation efficiency of the music content.

Accordingly, in the present technology, it is possible to improve the creation efficiency of the music content by automatically setting the marker which has been manually performed so far.

In other words, in the present technology, it is possible to improve the creation efficiency of the music content by setting the marker at an appropriate time position on the creation tool side without requiring the marker setting work by the user.

The time position of switching of a scene in a general musical content has the following Features F1 and F2.

(Feature F1)

In a certain track, the sound pressure of the audio signal changes at the time position of switching of a scene.

(Feature F2)

In a certain track, audio related information changes at the time position of switching of a scene.

Here, a specific example of Feature F1 will be described.

For example, at the time position at which the song that is a music content is switched from the intro to the verse, the sound pressure of the audio signal of a vocal track increases. That is, the audio signal of the vocal track changes from silence to sound.

Furthermore, for example, at the time position at which the song switches from the chorus to the outro, the sound pressure of the audio signal of the vocal track decreases. That is, the audio signal of the vocal track changes from sound to silence.

In addition, for example, at the time position at which the song is switched from the chorus to an interlude of guitar solos, the audio signal of a guitar track is continuously in a sound state, but the sound pressure of the audio signal increases.

Moreover, a specific example of Feature F2 will be described.

For example, as in the above-described example, the audio related information may be any information as long as it relates to the audio signal of the track, but here, it is assumed that the audio related information is musical instrument information, priority information, reverberation information, sound information, position information, or the like.

Feature F2 is a feature that the audio related information changes in a certain track at the time position of switching of a scene.

Specifically, for example, the audio signal of a drum track includes sounds of a plurality of percussive instruments included in the drum set. The percussive instrument included in the drum set described herein is, for example, a bass drum called a kick, a snare drum, a hi-hat, a cymbal, or the like.

Now, for example, in the audio signal of the drum track, it is assumed that there is a music content having a musical instrument configuration in which only hi-hat sound is included in the verse part of the song and the sound of the entire drum set, that is, the sound of each percussion instrument constituting the drum set is included in the bridge part.

In such a music content, the musical instrument information of the drum track changes from “hi-hat” to “drum” at the time position of switching from the verse to the bridge in the drum track.

Furthermore, for example, it is assumed that one vocalist is in charge while partially switching between a main vocal and a chorus, the verse includes a main vocal sound, and the bridge includes a vocal track including a chorus sound.

Here, for example, regarding the vocal track, it is assumed that priority information=high, reverberation information=dry, sound information=natural, and position information=center are set in the verse part, and priority information=medium, reverberation information=long reverb, sound information=dist, and position information=R are set in the bridge part.

In such a case, the priority information, the reverberation information, the sound information, and the position information as the audio related information change at the time position of switching from the verse to the bridge of the vocal track.

From the above, by setting the marker at the time position at which the sound pressure of the audio signal of each track and the audio related information change, it is possible to automatically set the marker indicating an appropriate time position, that is, the marker indicating the time position of switching of a scene.

Note that, in the following description, a marker that is not manually set by the user but is automatically set, that is, a marker set by the creation tool for music content is also particularly referred to as an automatic marker.

The setting of the automatic marker will now be described more specifically.

(B1) Set Automatic Marker on Basis of Sound Pressure of Audio Signal

First, an example of setting an automatic marker on the basis of a sound pressure of an audio signal will be described.

The sound pressure power(itrack, ifrm) in a predetermined time section (time frame) of the audio signal of the track constituting the music content can be obtained by the above-described Expression (1).

Here, as a method of setting the automatic marker on the basis of the sound pressure power(itrack, ifrm) of the audio signal, a method by threshold and a method by clustering will be described.

(B1-1) Method by Threshold

In the method by threshold, a time position to be a candidate for marker setting is determined for each track constituting the music content. Hereinafter, such a time position as a candidate for marker setting is referred to as an automatic marker candidate time position.

For example, a threshold process based on a predetermined power threshold thre_power is performed on the sound pressure power(itrack, ifrm) of the audio signal of the track, and the automatic marker candidate time position is determined on the basis of a processing result.

More specifically, for example, a time position at which the value of the sound pressure power(itrack, ifrm) has changed from a value smaller than the power threshold thre_power to a value larger than the power threshold thre_power or a time position at which the value of the sound pressure power(itrack, ifrm) has changed from a value larger than the power threshold thre_power to a value smaller than the power threshold thre_power is set as the automatic marker candidate time position of the track.

Thus, for example, a time position at which the audio signal of the track changes from silence to sound or a time position at which the audio signal changes from sound to silence is set as the automatic marker candidate time position.

Note that the power threshold thre_power may be one or a plurality of power thresholds thre_power. Furthermore, the power threshold thre_power may be set for each track.

When the automatic marker candidate time positions are obtained for all the tracks constituting the music content, the final automatic marker is set on the basis of the automatic marker candidate time positions obtained for all the tracks.

For example, in a case where the automatic marker candidate time positions of the number of tracks equal to or more than a predetermined track number threshold thre_tracks are included in a time section (hereinafter, also referred to as a time section duration) of predetermined duration seconds, the automatic marker is set at an intermediate time position of the time section. In other words, the automatic marker indicating a time position in the middle of the time section duration is generated.

Note that, hereinafter, the time position indicated by the automatic marker is also particularly referred to as an automatic marker time position. Setting the automatic marker in this manner can be said to be determining the automatic marker time position indicated by the automatic marker, that is, a time position of switching of a scene.

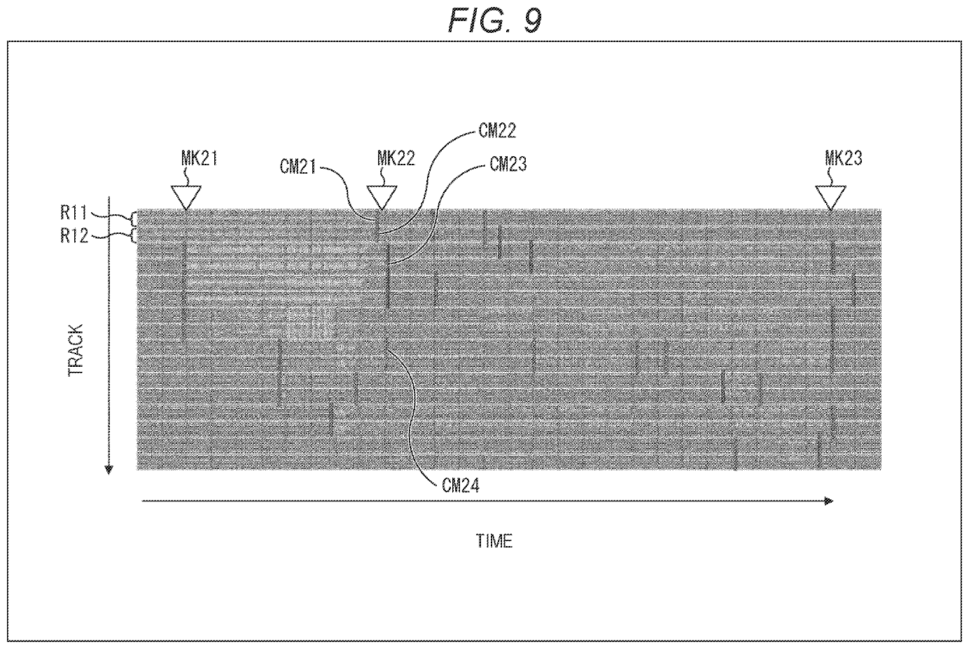

As a specific example, for the music content illustrated in FIG. 8, for example, when the automatic marker is set by the method by threshold, the automatic markers MK21 to MK23 are set as illustrated in FIG. 9, for example. Note that, in FIG. 9, portions corresponding to those in the case of FIG. 8 are denoted by the same reference numerals, and the description thereof will be omitted as appropriate.

In FIG. 9, a vertical line in the diagram drawn in each information display area represents an automatic marker candidate time position, and in this example, a plurality of time positions including the automatic marker candidate time positions CM21 to CM24 are set as the automatic marker candidate time positions.

For example, in the track in which the waveform information is displayed in the information display area R11, three time positions including the automatic marker candidate time position CM21 are set as the automatic marker candidate time positions.

Furthermore, in this example, the track number threshold thre_tracks=6 is set, the time section duration including the automatic marker candidate time positions of six or more tracks is detected, and the intermediate time position of the time section duration is set as the automatic marker time position. That is, the automatic marker indicating the intermediate time position of the time section duration is set.

In this example, for example, the automatic marker MK21 is set at a time position in the middle of the time section of duration seconds including six automatic marker candidate time positions.

Similarly, the automatic marker MK22 is set at the intermediate time position of the time section of duration seconds including the automatic marker candidate time positions of eight tracks including the automatic marker candidate time positions CM21 to CM24. Furthermore, the automatic marker MK23 is set at the intermediate time position of the time section of duration seconds including the automatic marker candidate time positions of the eight tracks.

For example, in the creation tool for music content of the present technology, the user can manually set the marker, or the marker (automatic marker) can be automatically set by the creation tool.

Furthermore, the user can also perform an operation on the automatic marker to manually adjust the automatic marker time position of the automatic marker or manually delete (cancel) an unnecessary automatic marker.

In setting the automatic markers, the number of automatic markers increases when the power threshold thre_power and the track number threshold thre_tracks are decreased, and conversely, the number of automatic markers decreases when the power threshold thre_power and the track number threshold thre_tracks are increased.

The power threshold thre_power and the track number threshold thre_tracks may be settable by the user.

In such a case, for example, it is conceivable that the power threshold thre_power and the track number threshold thre_tracks can be set by the user operating a bar or the like of a graphical user interface (GUI) displayed on the editing screen of the creation tool, such as the automatic marker sensitivity bar MSB11 illustrated in FIG. 2.

In this manner, the user can adjust the number of markers to be automatically set, and can set the automatic markers more matching the user's intention.

In addition, for example, the number of samples nsmp of the audio signal per time frame or the time section duration may be settable by the user. This allows the user to more finely adjust the number of automatic markers and the automatic marker time position.

As described above, in the method by threshold, the automatic marker candidate time position is determined for each track, and thereafter, the automatic marker time position is determined on the basis of the automatic marker candidate time position of each of the tracks, thereby setting the automatic marker.

(B1-2) Method by Clustering

Next, as a second method of setting the automatic marker on the basis of the sound pressure of the audio signal, a method by clustering will be described.

Note that, in the method by clustering, only the method of determining the automatic marker candidate time position is different from the above-described method by threshold, and the method of determining the automatic marker time position on the basis of the automatic marker candidate time position and setting the automatic marker is the same as the method by threshold.

Therefore, only the method of determining the automatic marker candidate time position will be described here for the method by clustering.

In the above-described method by threshold, for example, the time position at which the audio signal of the track changes from silence to sound or the time position at which the audio signal changes from sound to silence can be set as the automatic marker candidate time position.

However, in the method by threshold, although the audio signal remains as being sound, it is difficult to set the time position at which the sound pressure changes as the automatic marker candidate time position. Therefore, in the method by threshold, there is a case where an omission occurs in detection of the automatic marker candidate time position.

On the other hand, in the method by clustering, not only the time position at which the audio signal of the track changes from silence to sound or the time position at which the audio signal changes from sound to silence, but also the time position at which the audio signal remains to be sound and the sound pressure changes can be set as the automatic marker candidate time position.

The clustering is a method of dividing a target data set into subsets called clusters on the basis of a predetermined standard, and a k-means method or the like is widely known as a clustering algorithm.

Note that the clustering is described in detail in, for example, “O'Reilly Japan Publishing, Machine Learning with Python, by Andreas C. Muller et al., translated by Hideki Nakata”.

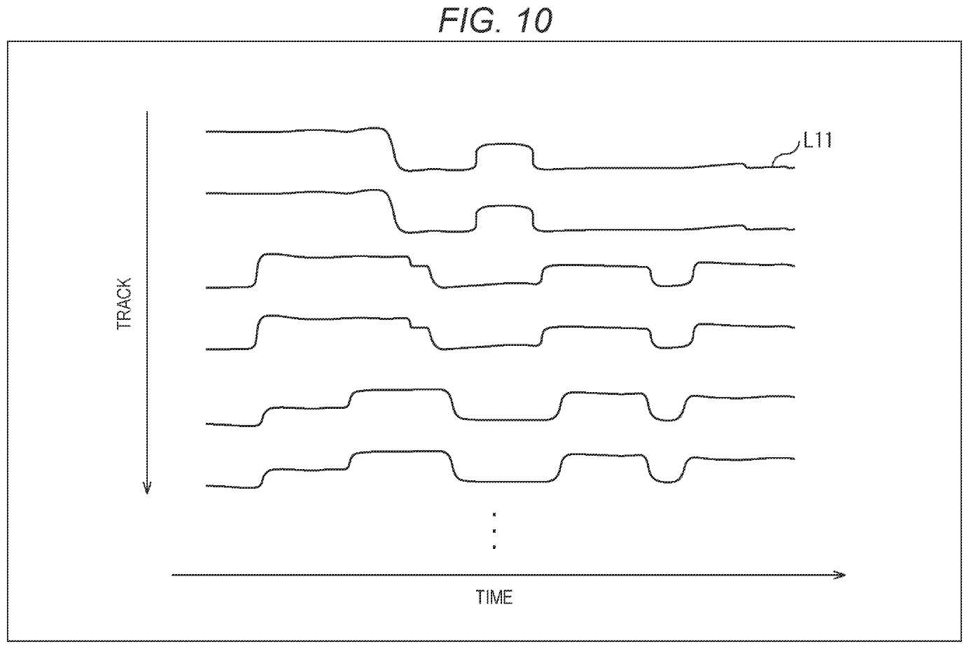

For example, the sound pressure power(itrack, ifrm) of each time frame (time) of the audio signal of each track described above, when plotted in time for each track, is as illustrated in FIG. 10.

Note that in FIG. 10, a horizontal direction indicates time. Furthermore, in FIG. 10, curves indicating the sound pressure of the audio signal of respective tracks are arranged in a vertical direction, and the position of a curve in the vertical direction in the diagram indicates the magnitude of the sound pressure power(itrack, ifrm).

Specifically, for example, a curve L11 represents sound pressure power(itrack, ifrm) in each time frame (time) of the audio signal of one track.

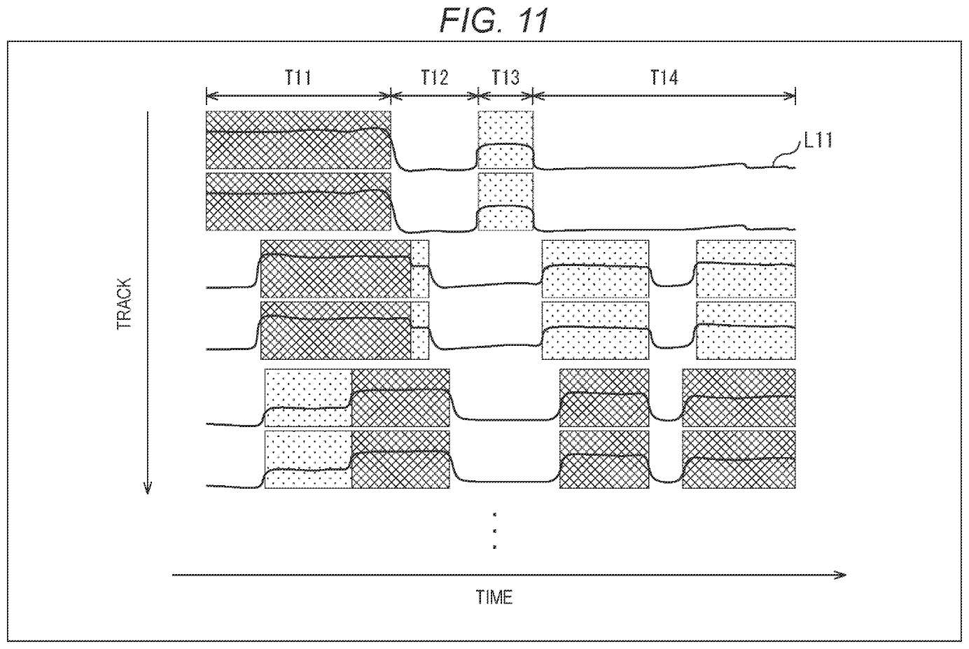

When k-means is applied to the data of such sound pressure of the audio signal of each track with the number of clusters k=3, the sound pressure of the audio signal of each track at each time is divided into a plurality of clusters as illustrated in FIG. 11. Note that, in FIG. 11, portions corresponding to those in the case of FIG. 10 are denoted by the same reference numerals, and the description thereof will be omitted as appropriate.

FIG. 11 illustrates a time section in which a shaded (hatched) time section or a non-hatched time section in a curve indicating the sound pressure at each time of the audio signal of the track has the sound pressure belonging to one cluster.

In this example, a set of the sound pressure power(itrack, ifrm) of the entire time frame of the audio signal is divided into three clusters according to the magnitude of the sound pressure power(itrack, ifrm). Thus, the entire time section of the audio signal is divided into time sections corresponding to the magnitude of the sound pressure power(itrack, ifrm).

For example, focusing on the curve L11, the track corresponding to the curve L11 is divided into four time sections of a time section T11 to a time section T14, and each of these time sections belongs to any of the three clusters.

In particular, here, the time section T11 is a time section belonging to a cluster having a large sound pressure power(itrack, ifrm), the time section T12 and the time section T14 are time sections belonging to a cluster having a small sound pressure power(itrack, ifrm), and the time section T13 is a time section belonging to a cluster having a medium sound pressure power(itrack, ifrm).

In the method by clustering, the time position at which the cluster changes in the entire time section of the audio signal for each track is set as the automatic marker candidate time position.

Therefore, in the track corresponding to the curve L11, the start position of the time section T12, the start position of the time section T13, and the start position of the time section 114 are set as the automatic marker candidate time positions.

After the automatic marker candidate time position is determined (detected) for each track by clustering, the automatic marker is set in a method similar to the method by threshold.

That is, for example, the automatic marker is set at an intermediate position of the time section duration including the automatic marker candidate time positions of the number of tracks equal to or more than the track number threshold thre_tracks.

According to the method by clustering as described above, the audio signal remains to be sound, such as the time position where the sound pressure changes from the cluster having the large sound pressure power(itrack, ifrm) to the cluster having a medium sound pressure power(itrack, ifrm), but the time position where the sound pressure changes can also be set as the automatic marker candidate time position. Thus, the occurrence of omission of detection of the automatic marker candidate time position can be suppressed, and the creation efficiency of the music content can be further improved.

Note that the number of clusters k at the time of clustering may be settable by the user. In this manner, it is possible to set the automatic marker more matching the user's intention.

Furthermore, a different number of clusters k may be used for each track or for each type of track indicated by the musical instrument information or the like. At this time, for example, the number of clusters k may be settable for each track by the user.

(B2) Set Automatic Marker on Basis of Audio Related Information

Next, an example of setting an automatic marker on the basis of the audio related information added to each track will be described.

For example, the musical instrument information, the priority information, the reverberation information, the sound information, the position information, and the like as the audio related information are added by the user or the like to each track constituting the music content.

As described above, the time position at which the values (setting values) of the musical instrument information, the priority information, the reverberation information, the sound information, and the position information as the audio related information change is often the time position of switching of a scene in the music content.

Accordingly, in a setting method of the automatic marker based on the audio related information, the time position at which the value of the audio related information is switched is set as the automatic marker candidate time position.

Then, the automatic marker is set on the basis of the automatic marker candidate time position determined for each track similarly to the method by threshold. That is, the automatic marker is set at the intermediate position of the time section duration including the automatic marker candidate time positions of the number of tracks equal to or more than the track number threshold thre_tracks.

Note that, for the audio related information represented by continuous values such as position information, clustering may be performed on the position information of each track changing in the time direction to determine the automatic marker candidate time position, similarly to the method by clustering.

Furthermore, the method of setting the automatic marker on the basis of the sound pressure of the audio signal and the method of setting the automatic marker on the basis of the audio related information have been described above.

Here, the information used for setting the automatic marker, that is, the information used for determining the automatic marker candidate time position may be any one or a plurality of the sound pressure of the audio signal, and the musical instrument information, the priority information, the reverberation information, the sound information, and the position information as the audio related information. Furthermore, what information is used to determine the automatic marker candidate time position may be settable by the user.

Moreover, in setting the automatic marker, the number of automatic markers (the number of markers) desired by the user may be settable by the user.

In this case, for example, the creation tool may set the automatic marker by all combinations of the information used for determining the automatic marker candidate time position and the parameters such as the track number threshold thre_tracks.

In such a case, the creation tool employs, as a final automatic marker setting result, a setting result when the number of automatic markers closest to the number of markers set by the user is set among the automatic marker setting results obtained by the respective combinations.

In a case where the user designates the setting method of the automatic marker as described above, that is, information used for setting the automatic marker (determining the automatic marker time position), for example, it is only required to operate the automatic marker setting button MCB11 in a state where the editing screen illustrated in FIG. 2 is displayed.

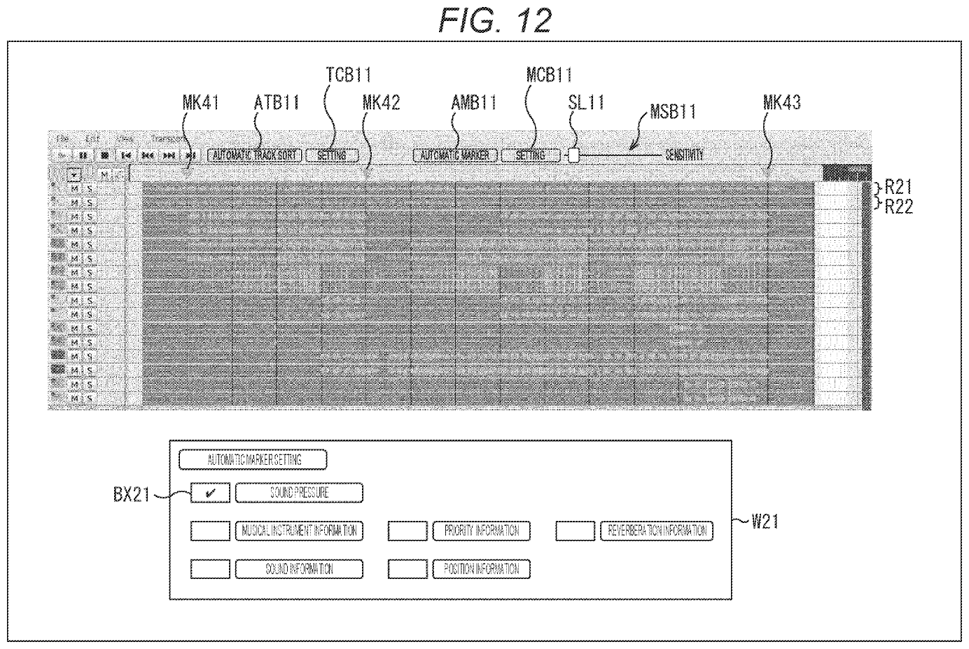

For example, when the user operates the automatic marker setting button MCB11, an automatic marker setting window W21 is displayed by superimposing on the editing screen as illustrated in FIG. 12. Note that, in FIG. 12, portions corresponding to those in the case of FIG. 2 are denoted by the same reference numerals, and the description thereof will be omitted as appropriate.

In the example of FIG. 12, letters indicating information available for setting of the automatic marker, that is, letters indicating a method of setting the automatic marker, and a check box for selecting (designating) to use the information are arranged and displayed in the automatic marker setting window W21.

For example, the check box BX21 arranged next to the letters “sound pressure” is for designating the sound pressure of the audio signal as information used for setting the automatic marker.

Similarly, in the automatic marker setting window W21, check boxes for designating the musical instrument information, the priority information, the reverberation information, the sound information, and the position information of the audio signal (track) are also displayed as information to be used for setting the automatic marker.

The user operates the check box displayed in this manner to display a check mark in a desired check box, thereby designating information used for setting the automatic marker, that is, a method of setting the automatic marker.

In this example, since a check mark is displayed in the check box BX21, it is a state that the setting of the automatic marker based on the sound pressure of the audio signal is selected (designated). Specifically, for example, it is a state that setting of the automatic marker by the above-described method by threshold or the method by clustering is selected.

In this manner, when the automatic marker button AMB11 is operated after the user displays the automatic marker setting window W21 and designates the information to be used for setting the automatic marker, the automatic marker is set on the basis of the information designated by the user.

Then, the automatic marker is displayed on the editing screen according to a setting result of the automatic marker. In the example of FIG. 12, a total of three automatic markers, automatic markers MK41 to MK43, are displayed.

Furthermore, the user can also adjust the number of automatic markers by moving the slider SL11 of the automatic marker sensitivity bar MSB11 in the horizontal direction in the diagram.

In particular, here, the position of the slider SL11 indicates the value of the track number threshold thre_tracks. For example, as the slider SL11 is moved to the left side in the diagram, the value of the track number threshold thre_tracks increases, and as a result, the number of automatic markers decreases.

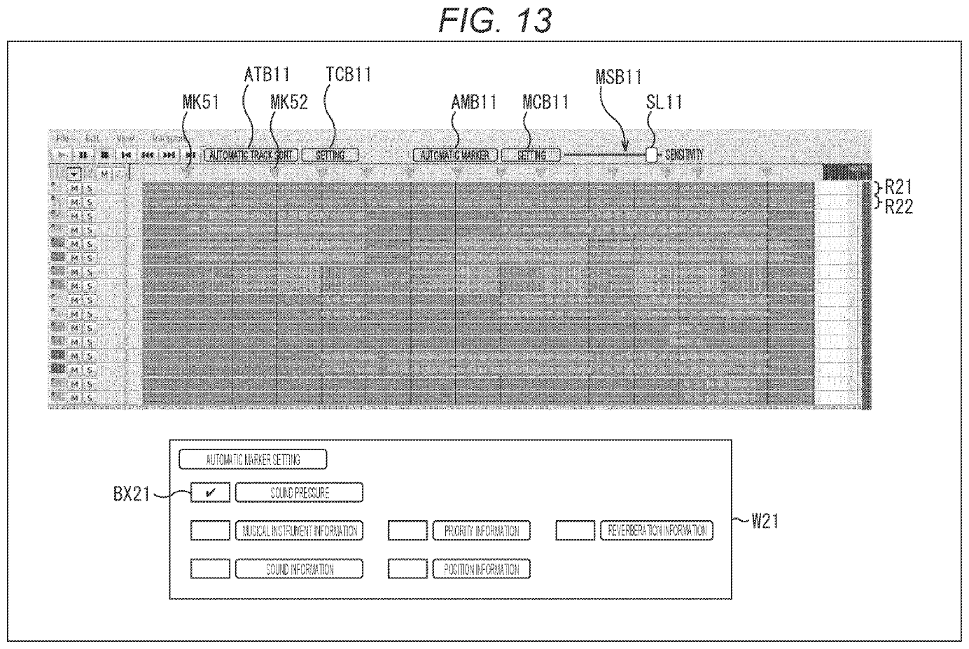

Therefore, for example, when the slider SL11 is moved rightward in the diagram from the state illustrated in FIG. 12, the value of the track number threshold thre_tracks decreases, and the number of automatic markers increases, for example, as illustrated in FIG. 13. Note that, in FIG. 13, portions corresponding to those in the case of FIG. 12 are denoted by the same reference numerals, and the description thereof will be omitted as appropriate.

In the example illustrated in FIG. 13, in the automatic marker setting window W21, a check mark is displayed in the check box BX21 as in the case of FIG. 12.

However, in FIG. 13, since the slider SL11 is positioned on the right side in the diagram as compared with the case in FIG. 12, more automatic markers are displayed as compared with the example illustrated in FIG. 12. That is, a total of 12 automatic markers including the automatic marker MK51 and the automatic marker MK52 are displayed on the editing screen illustrated in FIG. 13.

As described above, even when the automatic marker is set (determined) by the same method, the result varies depending on the values of the track number threshold thre_tracks and the power threshold thre_power.

By providing the automatic marker sensitivity bar MSB11 on the editing screen so that the user can designate the value of the track number threshold thre_tracks, it is possible to implement automatic marker setting that matches the user's intention.

Note that, similarly to the automatic marker sensitivity bar MSB11, a bar or the like for the user to designate the power threshold thre_power may also be provided on the editing screen.

<Configuration Example of Information Processing Device>

Next, a specific embodiment of an information processing device to which the present technology described above is applied will be described.

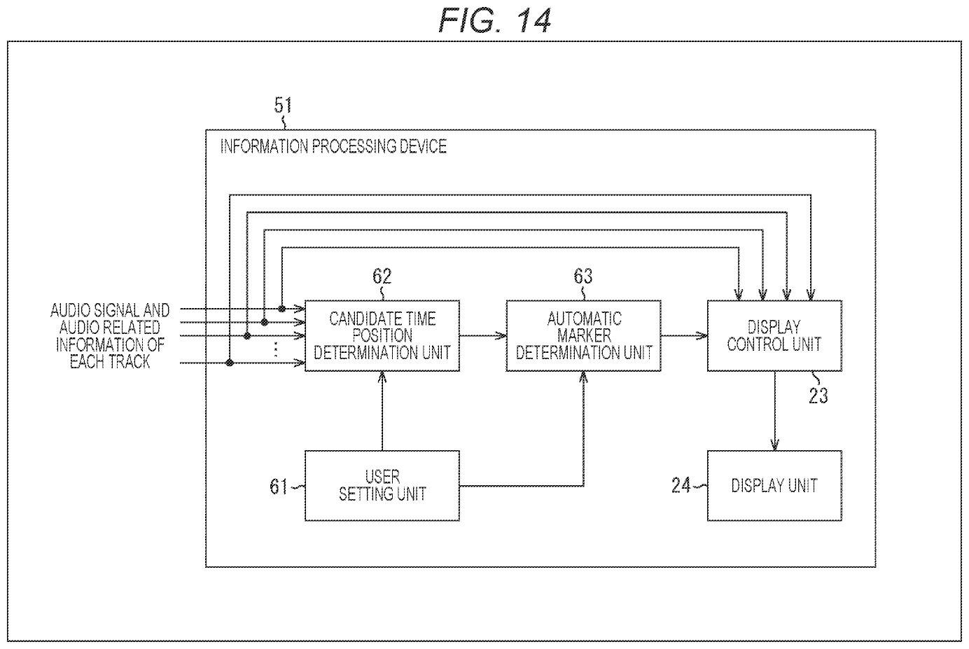

The information processing device to which the present technology is applied is configured as illustrated in FIG. 14, for example. Note that, in FIG. 14, portions corresponding to those in the case of FIG. 6 are denoted by the same reference numerals, and the description thereof will be omitted as appropriate.

An information processing device 51 illustrated in FIG. 14 includes, for example, a personal computer and the like, and achieves the creation tool for music content by executing a program.

The information processing device 51 includes a user setting unit 61, a candidate time position determination unit 62, an automatic marker determination unit 63, a display control unit 23, and a display unit 24.

The user setting unit 61 generates candidate determination designation information, candidate determination parameters, and marker setting parameters for designating information used for determining the automatic marker candidate time position in accordance with control such as a designation operation by the user.

Here, the candidate determination designation information is information indicating what kind of information is used for determining the automatic marker candidate time position, such as the sound pressure of the audio signal of the track or the musical instrument information as the audio related information.

In other words, the candidate determination designation information is information indicating how to set the automatic marker, such as the above-described method by threshold, method by clustering, or method based on the musical instrument information. The candidate determination designation information is, for example, information indicating a check box designated (selected) by the user in the automatic marker setting window W21 illustrated in FIG. 12.

Furthermore, the candidate determination parameters are various parameters used for determining the automatic marker candidate time position, and are, for example, the above-described power threshold thre_power, the number of clusters k, and the like.

Moreover, the marker setting parameters are various parameters used for setting the automatic marker, that is, determining the automatic marker time position, and are, for example, the track number threshold thre_tracks described above, the length duration of the time section, the number of automatic markers to be set, and the like.

The user setting unit 61 supplies the candidate determination designation information and the candidate determination parameters to the candidate time position determination unit 62, and supplies the marker setting parameters to the automatic marker determination unit 63.

The audio signal of each track of the music content and the audio related information of each track thereof are supplied from the creation tool for music content to the candidate time position determination unit 62.

The candidate time position determination unit 62 determines the automatic marker candidate time position for each track on the basis of the supplied audio signal and audio related information of each track and the candidate determination designation information and the candidate determination parameters supplied from the user setting unit 61, and supplies a determination result thereof to the automatic marker determination unit 63.

The automatic marker determination unit 63 sets the automatic marker by determining the automatic marker time position on the basis of the determination result of the automatic marker candidate time position supplied from the candidate time position determination unit 62 and the marker setting parameters supplied from the user setting unit 61. The automatic marker determination unit 63 supplies a setting result of the automatic marker to the display control unit 23.

The display control unit 23 generates display data of the editing screen on the basis of the audio signal and the audio related information of each track of the music content supplied from the creation tool for music content and the setting result of the automatic marker supplied from the automatic marker determination unit 63.

For example, the display control unit 23 generates image data for displaying the editing screen as display data such that the automatic marker is displayed at the automatic marker time position on the editing screen. Furthermore, the display control unit 23 supplies the generated display data to the display unit 24 to display the editing screen.

<Description of Editing Screen Display Process>

Next, operation of the information processing device 51 will be described.

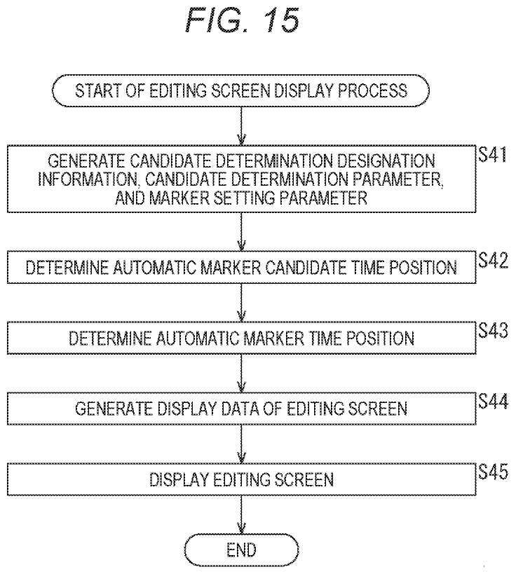

That is, the editing screen display process by the information processing device 51 will be described below with reference to the flowchart of FIG. 15.

In step S41, the user setting unit 61 generates the candidate determination designation information, the candidate determination parameters, and the marker setting parameters in accordance with control such as a designation operation by the user.

Then, the user setting unit 61 supplies the candidate determination designation information and the candidate determination parameters to the candidate time position determination unit 62, and supplies the marker setting parameters to the automatic marker determination unit 63.

For example, the user setting unit 61 generates the candidate determination designation information, the candidate determination parameters, and the marker setting parameters in accordance with the check box of the automatic marker setting window W21 illustrated in FIG. 12 or the operation on the automatic marker sensitivity bar MSB11 performed by the user.

In step S42, the candidate time position determination unit 62 determines the automatic marker candidate time position for each track on the basis of the supplied audio signal and audio related information of each track and the candidate determination designation information and the candidate determination parameters supplied from the user setting unit 61, and supplies a determination result thereof to the automatic marker determination unit 63.

For example, in a case where the automatic marker candidate time position is determined by the method by threshold according to the candidate determination designation information, the candidate time position determination unit 62 calculates the above-described Expression (1) to calculate the sound pressure power(itrack, ifrm) of the audio signal of each track.

Then, the candidate time position determination unit 62 performs the threshold process of comparing the sound pressure power(itrack, ifrm) of the audio signal of each track with the power threshold thre_power as a candidate determination parameter, and determines the automatic marker candidate time position for each track on the basis of the processing result.

Furthermore, for example, in a case where the automatic marker candidate time position is determined by the method by clustering according to the candidate determination designation information, the candidate time position determination unit 62 calculates the above-described Expression (1) to calculate the sound pressure power(itrack, ifrm) of the audio signal of each track.

Then, the candidate time position determination unit 62 determines an automatic marker candidate time position for each track by performing clustering on the sound pressure power(itrack, ifrm) of the audio signal for each track on the basis of the number of clusters k as a candidate determination parameter.

In addition, for example, in a case where the automatic marker candidate time position is determined on the basis of the audio related information according to the candidate determination designation information, the candidate time position determination unit 62 determines the automatic marker candidate time position on the basis of the musical instrument information, the priority information, the reverberation information, the sound information, and the position information of each track indicated by the candidate determination designation information.

In step S43, the automatic marker determination unit 63 determines the automatic marker time position on the basis of the determination result of the automatic marker candidate time position supplied from the candidate time position determination unit 62 and the marker setting parameters supplied from the user setting unit 61.

For example, the automatic marker determination unit 63 sets the automatic marker by determining the automatic marker time position on the basis of the track number threshold thre_tracks as a marker setting parameter, the length duration of the time section, the number of automatic markers to be set, and the like.

Specifically, for example, as described above, the intermediate position of the time section duration including the automatic marker candidate time positions of the number of tracks equal to or more than the track number threshold thre_tracks is determined as the automatic marker time position.

After setting the automatic marker by determining the automatic marker time position, the automatic marker determination unit 63 supplies a setting result thereof to the display control unit 23.

In step S44, the display control unit 23 generates display data of the editing screen on the basis of the supplied audio signal and audio related information of each track and the setting result of the automatic marker supplied from the automatic marker determination unit 63. Thus, for example, display data for displaying the editing screen illustrated in FIG. 12 is generated.

In step S45, the display control unit 23 supplies the generated display data to the display unit 24 to display the editing screen, and the editing screen display process ends.

As described above, the information processing device 51 determines the automatic marker time position on the basis of the audio signal and the audio related information of each track, and generates the display data of the editing screen.

In this manner, the automatic marker can be set at an appropriate time position without requiring a setting operation of the marker by the user, and the creation efficiency of the music content can be improved.

Note that the example of determining the track display sequence and the example of determining the automatic marker time position on the basis of the audio signal and the audio related information of each track have been described above. However, at the time of editing the music content, both the track display sequence and the automatic marker time position may be determined on the basis of the audio signal and the audio related information of each track, and the editing screen reflecting the determination result may be displayed.

<Configuration Example of Computer>

Incidentally, the series of processes described above can be executed by hardware, and can also be executed by software. In a case where the series of processes is executed by software, a program constituting the software is installed in a computer. Here, the computer includes a computer incorporated in dedicated hardware, a general-purpose personal computer for example that can execute various functions by installing various programs, and the like.

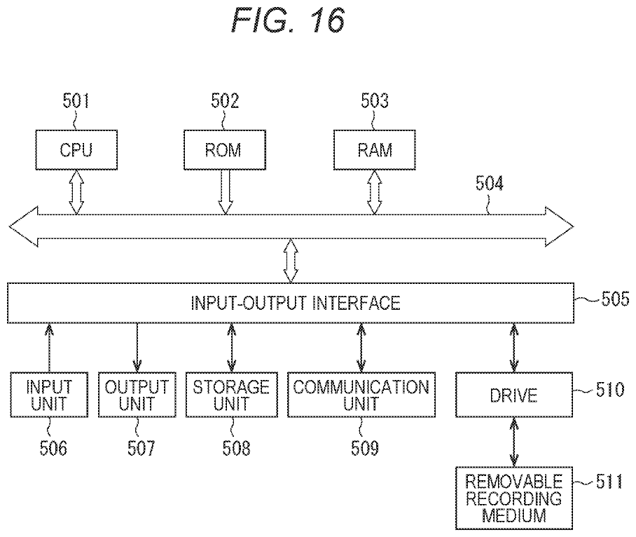

FIG. 16 is a block diagram illustrating a configuration example of hardware of a computer that executes the above-described series of processes by a program.

In the computer, a central processing unit (CPU) 501, a read only memory (ROM) 502, and a random access memory (RAM) 503 are interconnected via a bus 504.

An input-output interface 505 is further connected to the bus 504. An input unit 506, an output unit 507, a recording unit 508, a communication unit 509, and a drive 510 are connected to the input-output interface 505.

The input unit 506 includes a keyboard, a mouse, a microphone, an imaging element, and the like. The output unit 507 includes a display, a speaker, and the like. The recording unit 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input-output interface 505 and the bus 504, and executes the program, so as to perform the above-described series of processes.

The program executed by the computer (CPU 501) can be provided by being recorded on, for example, a removable recording medium 511 as a package medium or the like. Furthermore, the program can be provided via a wired or wireless transmission medium such as a local area network, the Internet, or digital satellite broadcasting.

In the computer, the program can be installed in the recording unit 508 via the input-output interface 505 by mounting the removable recording medium 511 to the drive 510. Furthermore, the program can be received by the communication unit 509 via a wired or wireless transmission medium and installed in the recording unit 508. In addition, the program can be installed in the ROM 502 or the recording unit 508 in advance.

Note that the program executed by the computer may be a program for processing in time series in the sequence described in the present description, or a program for processing in parallel or at a necessary timing such as when a call is made.

Furthermore, the embodiments of the present technology are not limited to the above-described embodiments, and various modifications are possible without departing from the scope of the present technology.

For example, the present technology can employ a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

Moreover, the present technology can also have the following configurations.

(1)

An information processing device including

a determination unit that, in a case where time-series display information regarding an audio signal of each of a plurality of tracks is arranged and displayed, determines a display sequence of the display information of the plurality of tracks or a time position of a marker indicating switching of a scene in the audio signal of the plurality of tracks on the basis of the audio signal of each of the plurality of tracks or audio related information regarding each of the plurality of the audio signals.

(2)

The information processing device according to (1), in which

the audio related information is designated by a user.

(3)

The information processing device according to (1) or (2), in which

the determination unit determines the display sequence of the display information for each of a plurality of time sections.

(4)

The information processing device according to (3), in which

the time section or a start position of the time section is designated by a user.

(5)

The information processing device according to any one of (1) to (4), in which

the audio related information is at least one of musical instrument information, priority information, reverberation information, sound information, or position information.

(6)

The information processing device according to any one of (1) to (5), in which

the determination unit determines the display sequence of the display information or the time position of the marker on the basis of a sound pressure of the audio signals.

(7)

The information processing device according to (6), in which

the determination unit determines the display sequence of the display information or the time position of the marker on the basis of a result of threshold process on the sound pressure.

(8)

The information processing device according to (7), further including

a candidate time position determination unit that determines a candidate time position that is a candidate for the time position of the marker for each of the plurality of tracks on the basis of a result of the threshold process, in which

the determination unit determines the time position of the marker on the basis of the candidate time position for each of the plurality of tracks.

(9)

The information processing device according to (6), further including

a candidate time position determination unit that performs clustering on the sound pressure at each time of the audio signal for each of the plurality of tracks to determine a candidate time position that is a candidate for the time position of the marker, in which

the determination unit determines the time position of the marker on the basis of the candidate time position for each of the plurality of tracks.

(10)

The information processing device according to any one of (1) to (7), in which

the determination unit
determines a display sequence of a group including one or a plurality of the tracks on the basis of the audio signals or the audio related information, and
further determines the display sequence of the display information of the one or the plurality of the tracks belonging to the group on the basis of the audio signal or the audio related information.

(11)

The information processing device according to any one of (1) to (10), further including

a display control unit that displays the display information of each of the plurality of tracks arranged and displayed in the display sequence.

(12)

The information processing device according to any one of (1) to (11), in which

the display information is waveform information, position information, gain information, or priority information of the audio signal.

(13)

An information processing method including

by an information processing device, in a case where time-series display information regarding an audio signal of each of a plurality of tracks is arranged and displayed, determining a display sequence of the display information of the plurality of tracks or a time position of a marker indicating switching of a scene in the audio signal of the plurality of tracks on the basis of the audio signal of each of the plurality of tracks or audio related information regarding each of the plurality of the audio signals.

(14)

A program causing a computer to execute processing including

a step of, in a case where time-series display information regarding an audio signal of each of a plurality of tracks is arranged and displayed, determining a display sequence of the display information of the plurality of tracks or a time position of a marker indicating switching of a scene in the audio signal of the plurality of tracks on the basis of the audio signal of each of the plurality of tracks or audio related information regarding each of the plurality of the audio signals.

### REFERENCE SIGNS LIST

11 Information processing device
21 User setting unit
22 Track display sequence determination unit
23 Display control unit
51 Information processing device
61 User setting unit
62 Candidate time position determination unit
63 Automatic marker determination unit

1. An information processing device comprising
a determination unit that, in a case where time-series display information regarding an audio signal of each of a plurality of tracks is arranged and displayed, determines a display sequence of the display information of the plurality of tracks or a time position of a marker indicating switching of a scene in the audio signal of the plurality of tracks on a basis of the audio signal of each of the plurality of tracks or audio related information regarding each of the plurality of the audio signals.

2. The information processing device according to claim 1, wherein
the audio related information is designated by a user.

3. The information processing device according to claim 1, wherein
the determination unit determines the display sequence of the display information for each of a plurality of time sections.

4. The information processing device according to claim 3, wherein
the time section or a start position of the time section is designated by a user.

5. The information processing device according to claim 1, wherein
the audio related information is at least one of musical instrument information, priority information, reverberation information, sound information, or position information.

6. The information processing device according to claim 1, wherein
the determination unit determines the display sequence of the display information or the time position of the marker on a basis of a sound pressure of the audio signals.

7. The information processing device according to claim 6, wherein
the determination unit determines the display sequence of the display information or the time position of the marker on a basis of a result of threshold process on the sound pressure.

8. The information processing device according to claim 7, further comprising
a candidate time position determination unit that determines a candidate time position that is a candidate for the time position of the marker for each of the plurality of tracks on a basis of a result of the threshold process, wherein
the determination unit determines the time position of the marker on a basis of the candidate time position for each of the plurality of tracks.

9. The information processing device according to claim 6, further comprising
a candidate time position determination unit that performs clustering on the sound pressure at each time of the audio signal for each of the plurality of tracks to determine a candidate time position that is a candidate for the time position of the marker, wherein
the determination unit determines the time position of the marker on a basis of the candidate time position for each of the plurality of tracks.

10. The information processing device according to claim 1, wherein
the determination unit
determines a display sequence of a group including one or a plurality of the tracks on a basis of the audio signals or the audio related information, and
further determines the display sequence of the display information of the one or the plurality of the tracks belonging to the group on a basis of the audio signal or the audio related information.

11. The information processing device according to claim 1, further comprising
a display control unit that displays the display information of each of the plurality of tracks arranged and displayed in the display sequence.

12. The information processing device according to claim 1, wherein
the display information is waveform information, position information, gain information, or priority information of the audio signal.

13. An information processing method comprising
by an information processing device, in a case where time-series display information regarding an audio signal of each of a plurality of tracks is arranged and displayed, determining a display sequence of the display information of the plurality of tracks or a time position of a marker indicating switching of a scene in the audio signal of the plurality of tracks on a basis of the audio signal of each of the plurality of tracks or audio related information regarding each of the plurality of the audio signals.

14. A program for causing a computer to execute processing comprising
a step of, in a case where time-series display information regarding an audio signal of each of a plurality of tracks is arranged and displayed, determining a display sequence of the display information of the plurality of tracks or a time position of a marker indicating switching of a scene in the audio signal of the plurality of tracks on a basis of the audio signal of each of the plurality of tracks or audio related information regarding each of the plurality of the audio signals.
